(19) United States
(12) Patent Application Publication
(10) Pub. No.: US 2009/0231365 A1
(43) Pub. Date: Sep. 17, 2009

(54) LIQUID CRYSTAL DISPLAY DRIVING DEVICE AND DRIVING METHOD

(76) Inventor: Xinshe YIN, Beijing (CN)

Correspondence Address: LADAS & PARRY LLP, 224 SOUTH MICHIGAN AVENUE, SUITE 1600, CHICAGO, IL, 60604, US

(21) Appl. No.: 12/275,263

(22) Filed: Nov. 21, 2008

(30) Foreign Application Priority Data
Mar. 14, 2008 (CN) 200810101995.5

(51) Int. Cl. G06F 3/038

(52) U.S. Cl. 345/690

(57) ABSTRACT

The present invention relates to a liquid crystal display driving device and driving method. The driving device comprises a liquid crystal display screen, a gate driver, a data driver and a timing controller. The timing controller is connected with the gate driver, the data driver and the timing controller, and is used for generating a grey level data signal and an internal logic synchronization signal in accordance with an input signal, and generating a gate scanning control signal, a data input control signal and a backlight source control signal in accordance with the internal logic synchronization signal and timing of data transmission channels, such that the backlight source is turned-off between the end time of the gate scanning control signal of the last line of the present frame and the start time of the gate scanning control signal of the first line of the next frame. The present invention controls the backlight source to be turned-off between two frames so as to make the liquid crystal display screen generate periodic black pictures, thereby the blur of the motion image due to the persistence of vision is effectively improved, and the picture quality is improved. Meanwhile, the power consumption of the backlight source is reduced, since the backlight source is turned-off between two frames.

### TECHNICAL FIELD

The present invention relates to a display driving device and driving method, and particularly, a liquid crystal display driving device and driving method.

### BACKGROUND ART

When displaying a still image, a liquid crystal display (LCD) has obvious advantages such as no flicker, whereas when displaying a moving image, it becomes blurry, which largely limits the application of the liquid crystal display in terms of digital TV, video playing and game.

The liquid crystal display in the prior art includes a liquid crystal display screen, a driving circuit (including a timing controller, a gate driver, a data driver), a backlight source and an inverter, the backlight source consisting of several CCFL lamps (or LED light source), an optical film and an outer frame. Light is emitted from the lamps, and transformed into a surface light source via a reflection film and a diffusion film (or prism film) to emit toward the liquid crystal display screen. When the liquid crystal display operates, pixels on the liquid crystal display screen are scanned line by line by the gate driver. All the pixels in one line are turned-on when this line is scanned, and the data driver writes a data voltage into the pixels in this line to charge the voltages of the pixels to a voltage required for displaying the picture. Liquid crystal molecules of a pixel are deflected under the electrical field to make the light of the backlight source passes through the pixel to form an image.

In the present liquid crystal displaying process, the backlight source keeps a turn-on state all the time, that is, the backlight source provides light all the time. In the pixel scanning process, after one line is scanned, the voltages of the pixels in this line will be held till the re-writing of the next frame data voltage, that is, the pixels in this line keep the written data voltage, and then the light passing through the pixels keeps the present grey level. When re-writing the next frame data, the grey level of the pixels in this line will transit directly to the grey level of the next frame, in this way, it is easy to generate retention of the initial picture in human eyes, and persistence of vision of the previous picture effects the receipt of vision to the next picture, resulting in a visual tailing which in turn directly renders picture blur.

### SUMMARY OF THE INVENTION

An object of the present invention is to provide a liquid crystal display driving device and driving method, which, by turning on/off a backlight source, effectively solves the picture blur due to the persistence of vision of the previous picture on the liquid crystal display in the prior art.

In order to achieve the above mentioned object, the present invention provides a liquid crystal display driving device, comprising:

a liquid crystal display screen, consisting of an array substrate, a color film substrate and liquid crystal disposed between the two substrates, and comprising pixels arranged in matrix form;

a timing controller, for generating a grey level data signal and an internal logic synchronization signal in accordance with an input signal, and generating a gate scanning control signal, a data input control signal and a backlight source control signal in accordance with the internal logic synchronization signal and timing of data transmitting channels;

a gate driver connected with the timing controller and the liquid crystal display screen, for line-scanning the pixels on the liquid crystal display screen in accordance with the gate scanning control signal;

a data driver connected with the timing controller and the liquid crystal display screen, for converting the grey level data signal into a scale voltage, and writing the scale voltage into the pixels on the liquid crystal display screen in accordance with the data input control signal; and

a backlight source, for providing the liquid crystal display screen with a surface light source, and the backlight source is controlled to be turned-off for a set period between the end time of the gate scanning control signal of the last line of the present frame and the start time of the gate scanning control signal of the first line of the next frame in accordance with the backlight source control signal.

Wherein the timing controller comprises:

a differential signal receiving module, for receiving a input differential signal, and generating the grey level data signal and the internal logic synchronization signal in accordance with the input differential signal;

a data processing module connected with the differential signal receiving module, for further processing the grey level data signal;

a differential signal transmitting module connected with the data processing module, for converting the grey level data signal into a differential signal and transmitting the differential signal to the data driver;

a gate driver control signal transmitting module connected to the differential signal receiving module, for generating the gate scanning control signal in accordance with the internal logic synchronization signal and the timing of the data transmitting channels, and transmitting the gate scanning control signal to the gate driver;

a data driver control signal transmitting module connected to the differential signal receiving module, for generating the data input control signal in accordance with the internal logic synchronization signal and the timing of the data transmitting channels, and transmitting the data input control signal to the data driver; and

a backlight source control signal transmitting module connected to the differential signal receiving module, for generating the backlight source control signal in accordance with the internal logic synchronization signal and the timing of the data transmitting channels, and transmitting the backlight source control signal to the backlight source via an inverter for controlling the backlight source to be turned-off for the set period between the end time of the gate scanning control signal of the last line of the present frame and the start time of the gate scanning control signal of the first line of the next frame.

In order to achieve the above mentioned object, the present invention also provides a liquid crystal display driving method, comprising: outputting, between the end time of the gate scanning control signal of the last line of the present frame and the start time of the gate scanning control signal of the first line of the next frame, a backlight source control signal for turning-off the backlight source.

Wherein, said outputting, between the end time of the gate scanning control signal of the last line of the present frame and the start time of the gate scanning control signal of the first line of the next frame, a backlight source control signal for tuning-off the backlight source particularly is: outputting the backlight source control signal for turning-off the backlight source for a set period after the end time of the gate scanning control signal of the last line of the present frame.

Said outputting the backlight source control signal for turning-off the backlight source for a set period after the end time of the gate scanning control signal of the last line of the present frame particularly is:

step 11, receiving the gate scanning control signal of the present frame;

step 12, determining whether the gate scanning control signal is for the last line, if so, performing step 13, otherwise, performing step 11;

step 13, generating and outputting the backlight source control signal for turning-off the backlight source for the set period; and

step 14, starting to scan the first line of the next frame, turning-on the backlight source, and performing step 11.

Furthermore, the set period is 0.1 ms˜10 ms.

The present invention proposes a liquid crystal display driving device and driving method, wherein, the backlight source is controlled to be turned-off between the end time of the gate scanning control signal of the last line of the present frame and the start time of the gate scanning control signal of the first line of the next frame so as to make the liquid crystal display screen generate periodic black pictures, such that the liquid crystal display transits from the present grey level to the grey level of the next picture via a black grey level of short duration when displaying pictures, which effectively improves the blur of the motion image due to the persistence of vision and thereby improves picture quality. Meanwhile, since the backlight source is turned-off between two frames, the power consumption of the backlight source is reduced. The present invention is easy to be implemented, and thus it has a broad application.

Hereinafter, the technical solution of the present invention will be further described in detail with reference to the drawings and embodiments.

### BRIEF DESCRIPTION OF THE DRAWINGS

FIG. 1 is a schematic drawing of the configuration of the liquid crystal display driving device of the present invention;

FIG. 2 is a schematic drawing of the configuration of the timing controller of the liquid crystal display driving device of the present invention;

FIG. 3 is a timing drawing of the backlight source control signal and the gate scanning control signal of the present invention;

FIG. 4 is a schematic drawing showing luminance variation of the pixels of the liquid crystal display screen of the present invention; and

FIG. 5 is a flowchart of one implementation solution of the liquid crystal display driving method of the present invention.

### DESCRIPTION OF THE REFERENCE SIGNS

10—liquid crystal display screen
30—inverter
50—data driver
21—differential signal receiving module
23—differential signal transmitting module
24—gate driver control signal transmitting module
25—data driver control signal transmitting module
26—backlight source control signal transmitting module
20—timing controller
40—gate driver
60—backlight source
22—data processing module

### DETAILED DESCRIPTION OF THE INVENTION

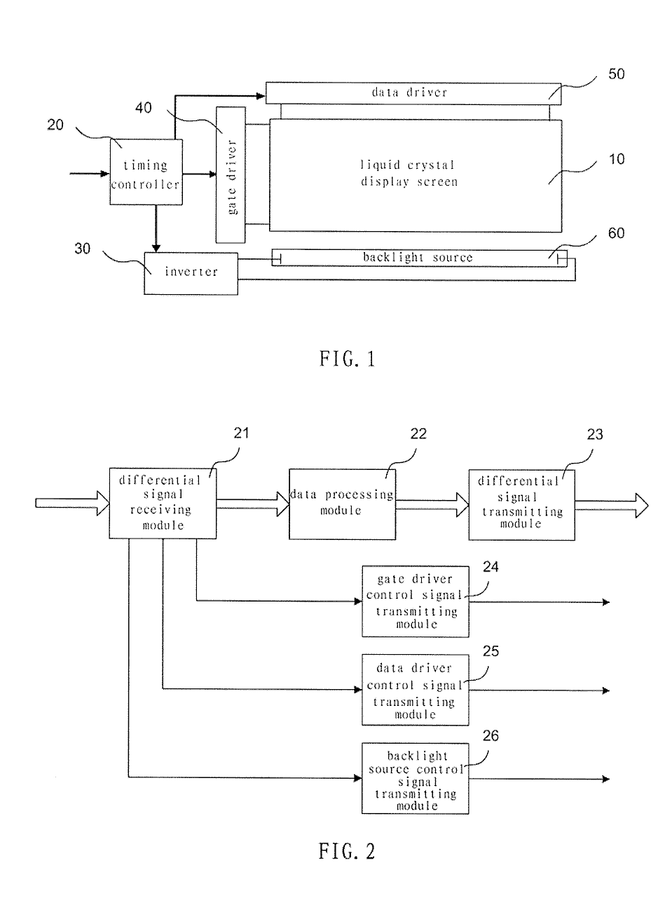

FIG. 1 is a schematic drawing of the configuration of the liquid crystal display driving device of the present invention. As shown in FIG. 1, the liquid crystal display driving device of the present invention comprises: a liquid crystal display screen 10, a timing controller 20, a gate controller 40, a data driver 50 and a backlight source 60. The liquid crystal display screen 10, which is located above the backlight source 60, consists of an array substrate, a color film substrate and liquid crystal disposed between the two substrates, and comprises pixels arranged in matrix form. The timing controller 20 is used for generating a grey level data signal and an internal logic synchronization signal in accordance with an input signal, and generating a gate scanning control signal, a data input control signal and a backlight source control signal in accordance with the internal logic synchronization signal and the timing of data transmitting channels. The gate driver 40 is connected with the liquid crystal display screen 10 and the timing controller 20, and for line-scanning the pixels on the liquid crystal display screen 10 in accordance with the gate scanning control signal. The data driver 50 is connected with the liquid crystal display screen 10 and the timing controller 20, and is used for converting the grey level data signal into a scale voltage, and writing the level signal into the pixels on the liquid crystal display screen 10 in accordance with the data input control signal. The backlight source 60 is controlled to be turned-off for a set period between the end time of the gate scanning control signal of the last line of the present frame and the start time of the gate scanning control signal of the first line of the next frame in accordance with the backlight source control signal. Particularly, the timing controller 20 is connected with the backlight source 60 via an inverter 30. The backlight source control signal generated by the timing controller 20 is generated at the end time of the gate scanning control signal of the last line of the present frame, and terminated at the start time of the gate scanning control signal of the first line of the next frame, and during this period, the backlight source 60 is turned-off, no light is emitted, and thus the liquid crystal display screen shows a black picture.

The above technical solution of the present invention proposes a novel liquid crystal display driving device, which controls the backlight source to be turned-off between two frames to make the liquid crystal display screen generate periodic black pictures, such that the liquid crystal display screen transits from the present grey level to the grey level of the next picture via a black grey level of short duration when displaying pictures. As for human vision, the periodic black screen may make the persistence of vision of human eyes black to further get ready to receive a new picture, therefore, the blur of the motion image due to the persistence of vision is effectively improved, and in turn the picture quality is improved. Meanwhile, since the backlight source is turned-off between two frames, the power consumption of the backlight source is reduced.

FIG. 2 is a schematic drawing of the configuration of the timing controller of the liquid crystal display driving device of the present invention. As shown in FIG. 2, the timing controller comprises: a differential signal receiving module 21, a data processing module 22, a differential signal transmitting module 23, a gate driver control signal transmitting module 24, a data driver control signal transmitting module 25 and a backlight source control signal transmitting module 26. The differential signal receiving module 21 is used for receiving an input differential signal and generating the grey level data signal and the internal logic synchronization signal in accordance with the input differential signal, wherein the internal logic synchronization signal comprises a line synchronization signal Hsync, a field synchronization signal Vsync and a data enable signal DE. The data processing module 22 is connected with the differential signal receiving module 21, and is used for further processing the grey level data signal. The differential signal transmitting module 23 is connected with the data processing module 22, and is used for converting the grey level data signal into a differential signal and transmitting the differential signal to the data driver 50. The gate driver control signal transmitting module 24 is connected to the differential signal receiving module 21, and is used for generating the gate scanning control signal in accordance with the internal logic synchronization signal and the timing of the data transmitting channels, and transmitting the gate scanning control signal to the gate driver 40. The data driver control signal transmitting module 25 is connected with the differential signal receiving module 21, and is used for generating the data input control signal in accordance with the internal logic synchronization signal and the timing of the data transmitting channels, and transmitting the data input control signal to the data driver 50. The backlight source control signal transmitting module 26 is connected with the differential signal receiving module 21, and is used for generating the backlight source control signal in accordance with the internal logic synchronization signal and the timing of the data transmitting channels, and transmitting the backlight source control signal to the backlight source 60 through the inverter 30 so as to control the backlight source 60 to be turned-off for a set period between the end time of the gate scanning control signal of the last line of the present frame and the start time of the gate scanning control signal of the first line of the next frame.

The liquid crystal display driving method of the present invention is: outputting, between the end time of the gate scanning control signal of the last line of the present frame and the start time of the gate scanning control signal of the first line of the next frame, a backlight source control signal for turning-off the backlight source.

The above mentioned technical solution of the present application proposes a novel liquid crystal display driving method, wherein the backlight source is controlled to be tuned-off between two frames to make the liquid crystal display screen generate periodic black pictures, such that the liquid crystal display screen transits from the present grey level to the grey level of the next picture via a black grey level of short duration when displaying pictures. As for human vision, the periodic black screens may make the persistence of vision of human eyes black so as to further get ready to receive a new picture, therefore, the blur of the motion image due to the persistence of vision is effectively improved, and in turn the picture quality is improved. Meanwhile, since the backlight source is turned-off between two frames, the power consumption of the backlight source is reduced.

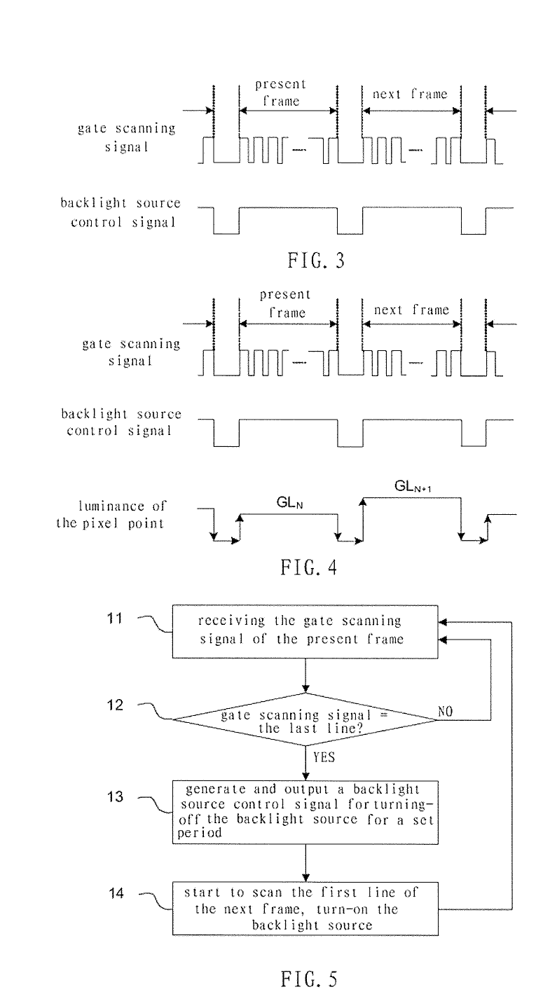

When the liquid crystal display is driven according to the prior art, the backlight source always emits light, no matter whether the gate driver is driven or not. One implementation solution of the liquid crystal display driving method according to the present invention is: setting a controller module in the timing controller to generate and output the backlight source control signal for controlling the backlight source to be turned-on/turned-off. FIG. 3 is a timing drawing of the backlight source control signal and the gate scanning control signal of the present invention, and FIG. 4 is a schematic drawing showing the luminance variation of the pixels of the liquid crystal display screen of the present invention. As shown in FIG. 3 and FIG. 4, between the end time of the gate scanning control signal of the present frame and the start time of the gate scanning control signal of the first line of the next frame, low level (or high level) of the backlight source control signal occurs. At the end time of the gate scanning control signal of the present frame, the pixels have a luminance of GL_{N}. At this time, the backlight source is turned off, the luminance of the pixels becomes 0, and the display panel shows a black screen. After the gate scanning control signal of the first line of the next frame starts, the pixels have a luminance of GL_{N+}1. That is, during the display of each picture, there is a time period of recovering from a display picture to a black picture and displaying a next frame from the black picture, which can effectively solve the persistence in human eyes of continuous pictures. A black picture about hundreds of microseconds to several milliseconds is inserted between two frames in the present invention, which helps to improve the picture quality. On the other hand, the power consumption of the backlight source is reduced approximately 3%-4%, since the backlight source is turned-off between the two frames.

In practice, the liquid crystal display driving method of the present invention can be implemented by employing the configuration of the liquid crystal display driving device according to the present invention. There are a plurality of implementation solutions of outputting a backlight source control signal between the end time of the gate scanning control signal of the last line of the present frame and the start time of the gate scanning control signal of the first line of the next frame, and preferably, the backlight source control signal for turning-off the backlight source for a set period can be outputted after the end time of the gate scanning control signal of the last line of the present frame, and the set period generally is 0.1 ms˜10 ms. FIG. 5 is a flowchart of one implementation solution of the liquid crystal display driving method according to the present invention, and particularly includes:
step 11, receiving the gate scanning control signal of the present frame;
step 12, determining whether the gate scanning control signal is for the last line, if so, performing step 13, otherwise, performing step 11;
step 13, generating and outputting the backlight source control signal, which causes the backlight source to be turned-off for the set period; and
step 14, starting to scan the first line of the next frame, turning-on the backlight source, and performing step 11.

The above embodiments are only for explaining the technical solution of the present invention but not limitative. Although the present invention has been described in detail with reference to the preferred embodiments, those skilled in the art should understand that modifications or equivalent alternations may be made to the technical solution of the present invention, without departing from the spirit and scope of the technical solution of the present invention.

1. A liquid crystal display driving device, comprising:
a liquid crystal display screen comprising an array substrate, a color film substrate and liquid crystal disposed between the two substrates, and comprising pixels arranged in matrix form;
a timing controller for generating a grey level data signal and an internal logic synchronization signal in accordance with an input signal, and generating a gate scanning control signal, a data input control signal and a backlight source control signal in accordance with the internal logic synchronization signal and timing of data transmitting channels;
a gate driver connected with the timing controller and the liquid crystal display screen, for line-scanning the pixels on the liquid crystal display screen in accordance with the gate scanning control signal;
a data driver connected with the timing controller and the liquid crystal display screen, for converting the grey level data signal into a scale voltage, and writing the scale voltage into the pixels on the liquid crystal display screen in accordance with the data input control signal; and
a backlight source for providing the liquid crystal display screen with a surface light source, and the backlight source is controlled to be turned-off for a set period between the end time of the gate scanning control signal of the last line of the present frame and the start time of the gate scanning control signal of the first line of the next frame in accordance with the backlight source control signal.

2. The liquid crystal display driving device of claim 1, wherein the timing controller comprises:
a differential signal receiving module for receiving a input differential signal, and generating the greylevel data signal and the internal logic synchronization signal in accordance with the input differential signal;
a data processing module connected with the differential signal receiving module, for further processing the grey level data signal;
a differential signal transmitting module connected with the data processing module, for converting the grey level data signal into a differential signal and transmitting the differential signal to the data driver;
a gate driver control signal transmitting module connected to the differential signal receiving module, for generating the gate scanning control signal in accordance with the internal logic synchronization signal and the timing of the data transmitting channels, and transmitting the gate scanning control signal to the gate driver;
a data driver control signal transmitting module connected to the differential signal receiving module, for generating the data input control signal in accordance with the internal logic synchronization signal and the timing of the data transmitting channels, and transmitting the data input control signal to the data driver; and
a backlight source control signal transmitting module connected to the differential signal receiving module, for generating the backlight source control signal in accordance with the internal logic synchronization signal and the timing of the data transmitting channels, and transmitting the backlight source control signal to the backlight source via an inverter for controlling the backlight source to be turned-off for the set period between the end time of the gate scanning control signal of the last line of the present frame and the start time of the gate scanning control signal of the first line of the next frame.

3. A liquid crystal display driving method, comprising: outputting, between the end time of the gate scanning control signal of the last line of the present frame and the start time of the gate scanning control signal of the first line of the next frame, a backlight source control signal for turning-off the backlight source.

4. The liquid crystal display driving method of claim 3, wherein said outputting, between the end time of the gate scanning control signal of the last line of the present frame and the start time of the gate scanning control signal of the first line of the next frame, a backlight source control signal for turning-off the backlight source particularly is: outputting the backlight source control signal for turning-off the backlight source for a set period after the end time of the gate scanning control signal of the last line of the present frame.

5. The liquid crystal display driving method of claim 4, wherein said outputting the backlight source control signal for turning-off the backlight source for a set period after the end time of the gate scanning control signal of the last line of the present frame particularly is:
step 11, receiving the gate scanning control signal of the present frame;
step 12, determining whether the gate scanning control signal is for the last line, if so, performing step 13, otherwise, performing step 11;
step 13, generating and outputting the backlight source control signal for turning-off the backlight source for the set period; and
step 14, starting to scan the first line of the next frame, turning-on the backlight source, and performing step 11.

6. The liquid crystal display driving method according to claim 3, wherein the set period is 0.1 ms˜10 ms.

7. The liquid crystal display driving method according to claim 4, wherein the set period is 0.1 ms˜10 ms.

8. The liquid crystal display driving method according to claim 5, wherein the set period is 0.1 ms˜10 ms.
